(19) United States
(12) Patent Application Publication
(10) Pub. No.: US 2026/0073124 A1
(43) Pub. Date: Mar. 12, 2026

(54) DOCUMENT SUMMARIZATION APPARATUS, METHOD, AND NON-TRANSITORY COMPUTER READABLE MEDIUM

(71) Applicant: KABUSHIKI KAISHA TOSHIBA, Tokyo (JP)

(72) Inventors: Tomohiro YAMASAKI, Tokyo (JP); Kazunori IMOTO, Kawasaki Kanagawa (JP)

(73) Assignee: KABUSHIKI KAISHA TOSHIBA, Tokyo (JP)

(21) Appl. No.: 19/248,312

(22) Filed: Jun. 24, 2025

(30) Foreign Application Priority Data
Sep. 9, 2024 (JP) 2024-154828

(51) Int. Cl. G06F 40/166; G06F 40/30

(52) U.S. Cl. CPC G06F 40/166; G06F 40/30

(57) ABSTRACT

According to one embodiment, a document summarization apparatus includes a processor. The processor performs natural language processing on text included in a document to extract a plurality of linguistic representations and a first semantic relationship between the linguistic representations from the text. The processor classifies the linguistic representations into a plurality of clusters by semantic similarity. The processor determines a second semantic relationship between the clusters based on the first semantic relationship. The processor generates a graph representing the clusters and the second semantic relationship.

### CROSS-REFERENCE TO RELATED APPLICATION

This application is based upon and claims the benefit of priority from Japanese Patent Application No. 2024-154828, filed Sep. 9, 2024, the entire contents of which are incorporated herein by reference.

### FIELD

Embodiments described herein relate generally to a document summarization apparatus, a method, and a non-transitory computer readable medium.

### BACKGROUND

In the manufacturing industry, a document that reports troubles that have occurred during operations (hereinafter referred to as “trouble report”) is conventionally prepared. Generally, a trouble report records various events (for example, phenomenon, investigation, cause, countermeasure, and result) regarding a trouble as text of a natural sentence. The trouble report contributes to prevention of recurrence of similar troubles and quick resolution.

In the trouble report, text regarding various events can be enormous or complex. To summarize such a trouble report, the conventional art performs natural language processing on text included in the trouble report to extract a plurality of linguistic representations and a semantic relationship between the plurality of linguistic representations from the text to present to a user.

However, the trouble report may contain a number of linguistic representations. As a result, if all the linguistic representations and the semantic relationship extracted from the trouble report are presented to the user, it is difficult for the user to understand the presented information at a glance.

### BRIEF DESCRIPTION OF DRAWINGS

FIG. 1 is a functional configuration diagram of a document summarization apparatus according to a first embodiment.

FIG. 2 is a flowchart of the document summarization apparatus according to the first embodiment.

FIG. 3 is a diagram illustrating natural language processing for text included in a document.

FIG. 4 is a diagram illustrating classification processing of a plurality of linguistic representations.

FIG. 5 is a diagram illustrating determination processing of a semantic relationship between a plurality of clusters.

FIG. 6 is a diagram illustrating a graph.

FIG. 7 is a functional configuration diagram of a document summarization apparatus according to a second embodiment.

FIG. 8 is a flowchart of the document summarization apparatus according to the second embodiment.

FIG. 9 is a diagram illustrating processing of specifying a portion from a graph.

FIG. 10 is a diagram illustrating an example of a partial graph.

FIG. 11 is a functional configuration diagram of a document summarization apparatus according to a third embodiment.

FIG. 12 is a flowchart of the document summarization apparatus according to the third embodiment.

FIG. 13 is a diagram illustrating another example of a partial graph.

FIG. 14 is a functional configuration diagram of a document summarization apparatus according to a fourth embodiment.

FIG. 15 is a flowchart of the document summarization apparatus according to the fourth embodiment.

FIG. 16 is a diagram illustrating conversion processing from a linguistic representation to another linguistic representation.

FIG. 17 is a diagram illustrating conversion processing from the linguistic representation to an image.

FIG. 18 is a diagram illustrating an example of display screen transition processing according to a modification.

FIG. 19 is a diagram illustrating another example of display screen transition processing according to a modification.

FIG. 20 is a hardware configuration diagram of the document summarization apparatus according to each embodiment.

### DETAILED DESCRIPTION

In general, according to one embodiment, a document summarization apparatus includes a processor. The processor performs natural language processing on text included in a document to extract a plurality of linguistic representations and a first semantic relationship between the linguistic representations from the text. The processor classifies the linguistic representations into a plurality of clusters by semantic similarity. The processor determines a second semantic relationship between the clusters based on the first semantic relationship. The processor generates a graph representing the clusters and the second semantic relationship.

Hereinafter, each embodiment will be described with reference to the drawings. A plurality of portions denoted by the same reference numeral is regarded as the same, and redundant description will be omitted as appropriate.

### First Embodiment

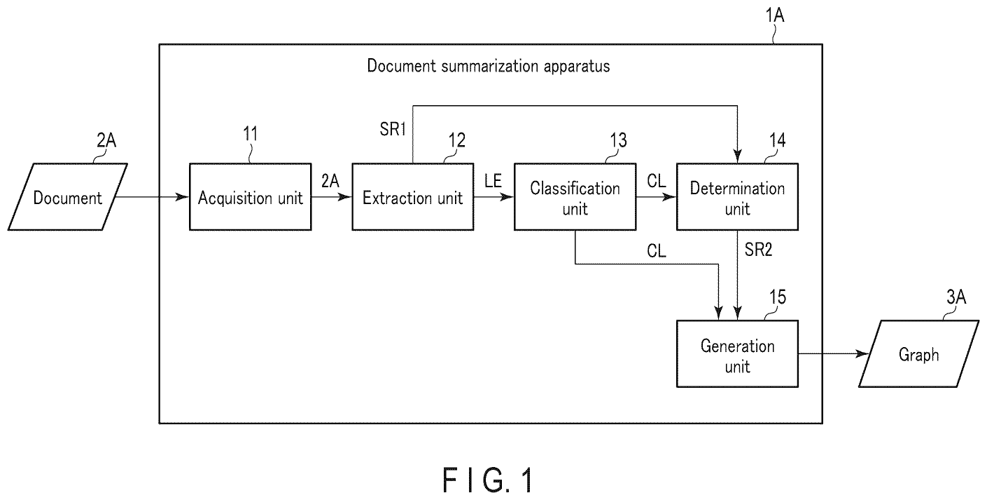

FIG. 1 is a functional configuration diagram of a document summarization apparatus 1A according to a first embodiment. The document summarization apparatus 1A is an apparatus that summarizes a document. The document summarization apparatus 1A includes an acquisition unit 11, an extraction unit 12, a classification unit 13, a determination unit 14, and a generation unit 15.

The acquisition unit 11 is a unit that acquires various data. The acquisition unit 11 acquires a document 2A from an external database or the like. The acquisition unit 11 transmits the document 2A to the extraction unit 12.

The document 2A is electronized document data (for example, text data). The document 2A may be a trouble report. The trouble report records various events (for example, a phenomenon, investigation, cause, countermeasure, and result) regarding a trouble as text of a natural sentence. The trouble report records a phenomenon as a trouble, an investigation for investigating a cause of the phenomenon, a cause found as a result of the investigation, a countermeasure against the cause, a result of the countermeasure, and the like. The trouble report may be associated with a department, a device number, a manufacturing process, an apparatus, and the like.

The extraction unit 12 is a unit that extracts various data. The extraction unit 12 executes natural language processing for text included in the document 2A received from the acquisition unit 11, and extracts a plurality of linguistic representations LE and a semantic relationship (hereinafter also referred to as a “first semantic relationship SR1”) between the plurality of linguistic representations LE from the text. The extraction unit 12 may extract the plurality of linguistic representations LE by executing named entity extraction. The extraction unit 12 may extract the first semantic relationship SR1 by executing relationship extraction. The extraction unit 12 transmits the plurality of extracted linguistic representations LE to the classification unit 13, and transmits the extracted first semantic relationship SR1 to the determination unit 14.

The linguistic representation LE is a linguistic expression including a plurality of words. The linguistic representation LE is a phrase, a clause, or a sentence. The linguistic representation LE is also referred to as “tag text”.

The classification unit 13 is a unit that classifies various data. The classification unit 13 classifies the plurality of linguistic representations LE received from the extraction unit 12 into a plurality of clusters CL based on semantic similarity. The classification unit 13 may classify the plurality of linguistic representations LE into the plurality of clusters CL by performing hierarchical clustering or non-hierarchical clustering. The classification unit 13 transmits the plurality of clusters CL to the determination unit 14 and the generation unit 15.

The determination unit 14 is a unit that determines various data. The determination unit 14 determines a semantic relationship (hereinafter also referred to as a “second semantic relationship SR2”) between the plurality of clusters CL received from the classification unit 13 based on the first semantic relationship SR1 received from the extraction unit 12. For a first cluster and a second cluster among the plurality of clusters CL, the determination unit 14 determines the second semantic relationship SR2 between the first cluster and the second cluster based on the first semantic relationship SR1 between the plurality of first linguistic representations included in the first cluster and the plurality of second linguistic representations included in the second cluster. The determination unit 14 may determine the first semantic relationship SR1 between one of the plurality of first linguistic representations and one of the plurality of second linguistic representations as the second semantic relationship SR2 between the first cluster and the second cluster. The determination unit 14 transmits the determined second semantic relationship SR2 to the generation unit 15.

The generation unit 15 is a unit that generates various data. The generation unit 15 generates a graph 3A expressing the plurality of clusters CL received from the classification unit 13 and the second semantic relationship SR2 received from the determination unit 14. The generation unit 15 outputs the generated graph 3A to an external display device or the like.

The graph 3A is electronized graph data (for example, image data). The graph 3A may express the cluster CL as a node, and may express the second semantic relationship SR2 between the plurality of clusters CL as an edge. The graph 3A may be an undirected graph or a directed graph.

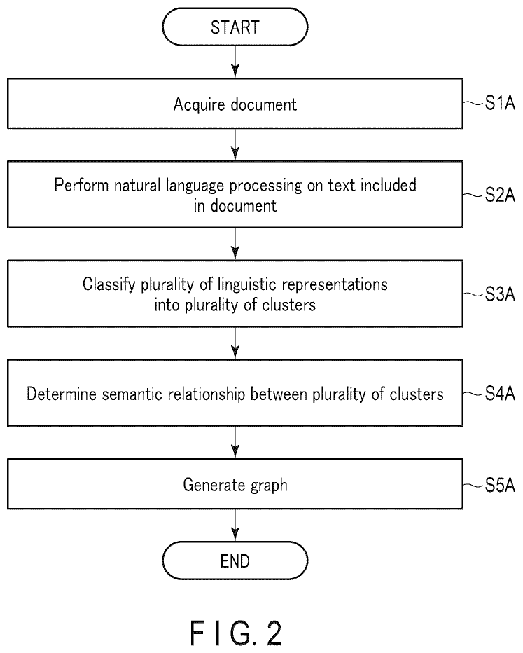

FIG. 2 is a flowchart of the document summarization apparatus 1A according to the first embodiment. The document summarization apparatus 1A executes the following steps S1A to S5A.

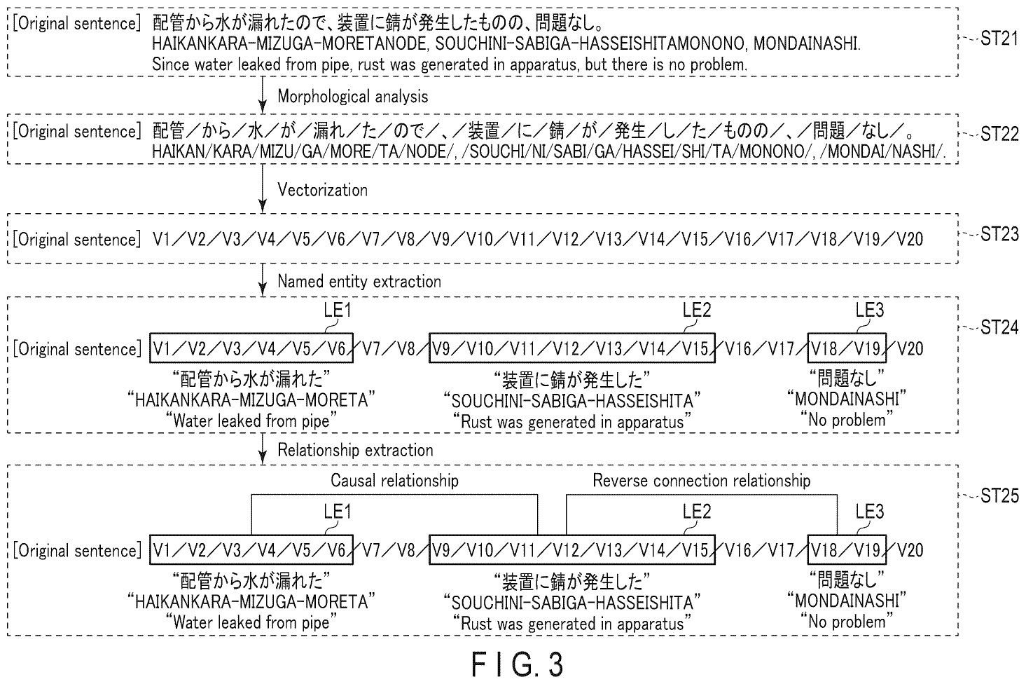

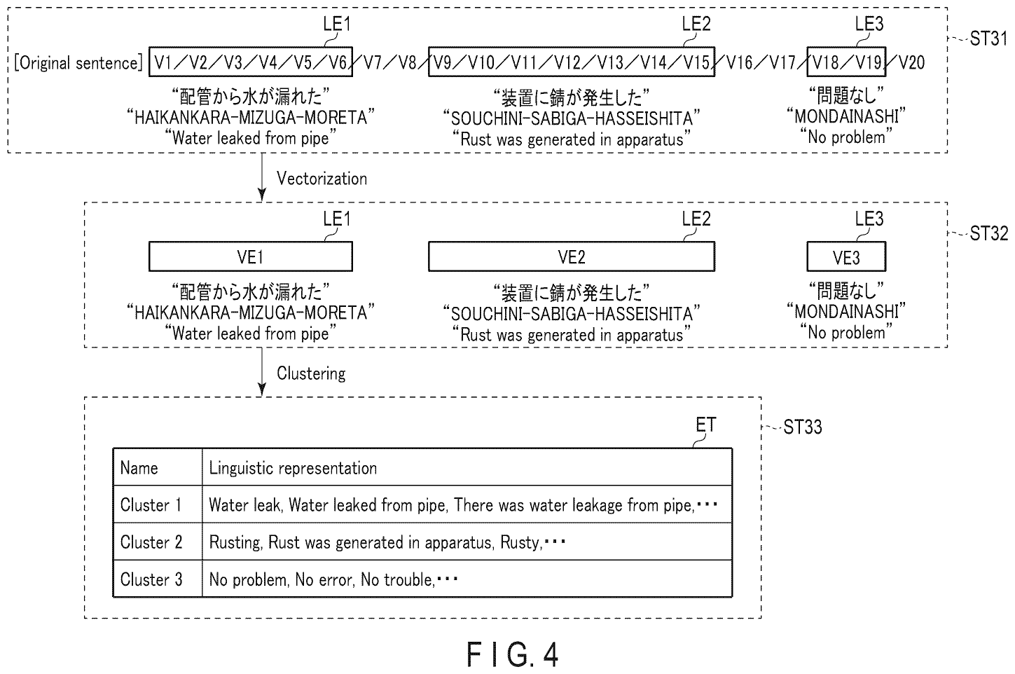

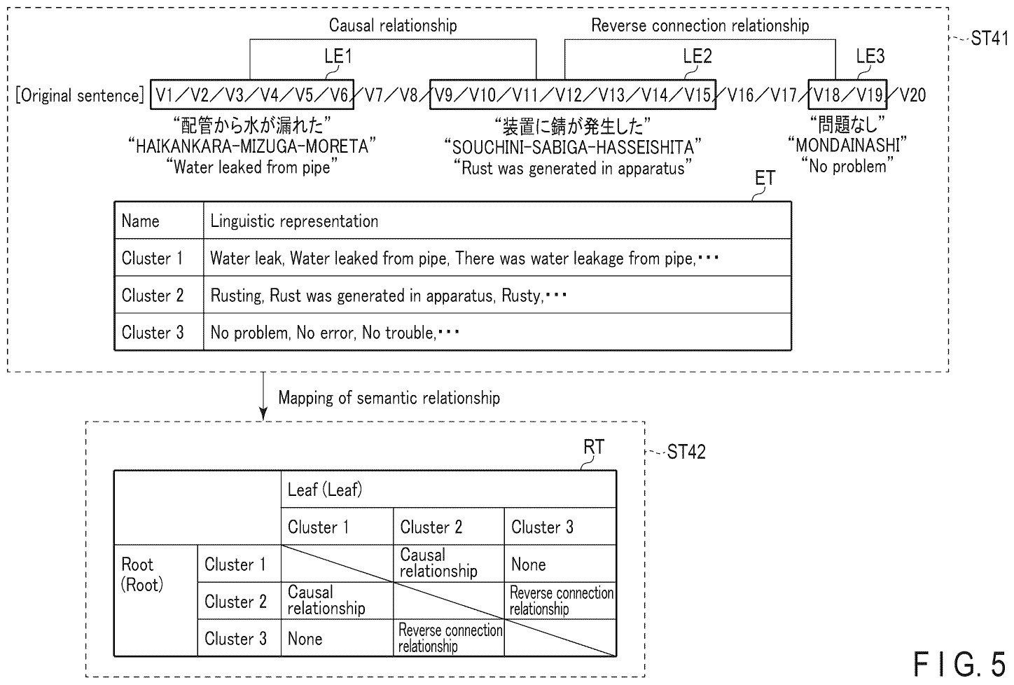

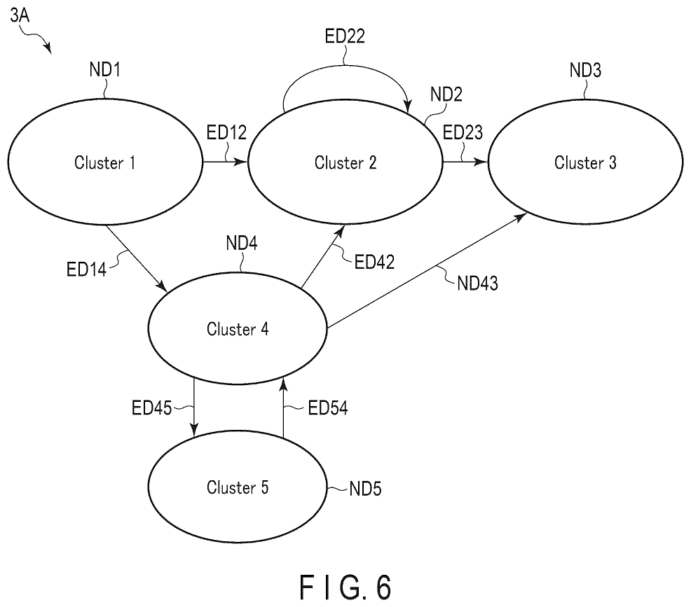

(Step S1A) First, the acquisition unit 11 acquires a document 2A. For example, the acquisition unit 11 acquires the document 2A from the external database or the like.
(Step S2A) Next, the extraction unit 12 performs natural language processing on text included in the document 2A. For example, the extraction unit 12 extracts a plurality of linguistic representations LE and a first semantic relationship SR1 between the plurality of linguistic representations LE from the text by performing named entity extraction and relationship extraction on the text (see FIG. 3).
(Step S3A) Subsequently, the classification unit 13 classifies the plurality of linguistic representations LE into a plurality of clusters CL. For example, the classification unit 13 classifies the plurality of linguistic representations LE into the plurality of clusters CL based on semantic similarity by performing hierarchical clustering or non-hierarchical clustering (see FIG. 4).
(Step S4A) Subsequently, the determination unit 14 determines a semantic relationship (second semantic relationship SR2) between the plurality of clusters CL. For example, the determination unit 14 determines the second semantic relationship SR2 between the plurality of clusters CL based on the first semantic relationship SR1 between the plurality of linguistic representations LE among the plurality of clusters CL (see FIG. 5).
(Step S5A) Finally, the generation unit 15 generates a graph 3A. For example, the generation unit 15 generates the graph 3A based on the plurality of clusters CL and the second semantic relationship SR2 (see FIG. 6).

FIG. 3 is a diagram illustrating natural language processing for the text included in the document 2A. The extraction unit 12 executes (1) morphological analysis, (2) vectorization, (3) named entity extraction, and (4) relationship extraction as the natural language processing.

For example, the extraction unit 12 starts a series of processing on an original sentence “HAIKANKARA-MIZUGA-MORETANODE, SOUCHINI-SABIGA-HASSEISHITAMONONO, MONDAINASHI. (Since water leaked from pipe, rust was generated in apparatus, but there is no problem.)” as a text (stage ST21). First, the extraction unit 12 performs morphological analysis on the original sentence and divides the original sentence into a plurality of words (stage ST22). Next, the extraction unit 12 vectorizes the divided words (stage ST23). The extraction unit 12 may vectorize the words using a known language model (for example, Word2Vec, BERT). As a result, the original sentence is vectorized into vectors V1 to V20. Each of the vectors V1 to V20 corresponds to each word.

Subsequently, the extraction unit 12 extracts a linguistic representation LE from the plurality of vectorized words (stage ST24). The extraction unit 12 may extract the linguistic representation LE using a previously-trained language model (for example, a neural network). As a result, three linguistic representations LE1, LE2, and LE3 are extracted from the vectors V1 to V20. The linguistic representation LE1 corresponds to the vectors V1 to V6 and corresponds to “HAIKANKARA-MIZUGA-MORETA (Water leaked from pipe)” of the original sentence. The linguistic representation LE2 corresponds to the vectors V9 to V15 and corresponds to “SOUCHINI-SABIGA-HASSEISHITA (Rust was generated in apparatus)” of the original sentence. The linguistic representation LE3 corresponds to the vectors V18 to V19 and corresponds to “MONDAINASHI (No problem)” of the original sentence.

Finally, the extraction unit 12 extracts a first semantic relationship SR1 between the plurality of linguistic representations LE (stage ST25). The extraction unit 12 may extract the first semantic relationship SR1 using a previously-trained language model (for example, a neural network). The extraction unit 12 may extract the first semantic relationship SR1 between two linguistic representations LE based on a word existing between the two linguistic representations LE.

For example, the extraction unit 12 extracts a “Causal relationship” from between the two linguistic representations LE1 and LE2 based on a word “NODE (since)” (corresponding to the vector V7) existing between the two linguistic representations LE1 and LE2. The causal relationship may be directed from the linguistic representation LE1 to the linguistic representation LE2. Similarly, the extraction unit 12 extracts a “Reverse connection relationship” from between the two linguistic representations LE2 and LE3 based on a word “MONONO (but)” (corresponding to the vector V16) existing between the two linguistic representations LE2 and LE3.

FIG. 4 is a diagram illustrating classification processing of the plurality of linguistic representations LE. The classification unit 13 executes (1) vectorization and (2) clustering as the classification processing. For example, the classification unit 13 starts a series of processing on the original sentence in the state illustrated in stage ST24 (see FIG. 3) (stage ST31). First, the classification unit 13 vectorizes the linguistic representation LE extracted from the original sentence (stage ST32). The classification unit 13 may vectorize the linguistic representation LE using a known language model (for example, Word2Vec, BERT). The classification unit 13 may average a plurality of vectors corresponding to the plurality of words in the linguistic representation LE to vectorize the linguistic representation LE. As a result, the three linguistic representations LE1, LE2 and LE3 are vectorized into three vectors VE1, VE2 and VE3, respectively.

Finally, the classification unit 13 clusters a plurality of vectors VE respectively corresponding to the plurality of linguistic representations LE (stage ST33). The classification unit 13 may cluster the plurality of vectors VE adjacent to each other in a vector space by a hierarchical method (for example, Ward's method) or a non-hierarchical method (for example, K-means method).

The classification unit 13 may determine accuracy of clustering based on a result of clustering pairs of linguistic representations LE to belong to the same (or different) cluster. For example, the classification unit 13 may quantitatively determine the accuracy of clustering based on a distance between the pair of linguistic representations LE clustered in the vector space. As a result, the three linguistic representations LE1, LE2 and LE3 are clustered into three clusters (Cluster 1, Cluster 2, and Cluster 3), respectively.

A representation table ET indicates names of three clusters and a plurality of linguistic representations LE classified into three clusters. The representation table ET further shows a result of clustering related to other plurality of linguistic representations LE in addition to the three linguistic representations LE1, LE2, and LE3. Specifically, a cluster 1 includes a plurality of linguistic representations LE (for example, Water leak, Water leaked from pipe, and There was water leakage from pipe). A cluster 2 includes a plurality of linguistic representations LE (for example, Rusting, Rust was generated in apparatus, and Rusty). A cluster 3 includes a plurality of linguistic representations LE (for example, No problem, No error, No trouble).

A vector VE corresponding to a certain linguistic representation LE indicates meaning of the linguistic representation LE. Therefore, the classification unit 13 can collect a plurality of linguistic representations LE having similar meanings in the same cluster by clustering a plurality of vectors VE. For example, the cluster 1 includes a plurality of linguistic representations LE having a meaning similar to “Water leak”. The cluster 2 includes a plurality of linguistic representations LE having a meaning similar to “Rusting”. The cluster 3 includes a plurality of linguistic representations LE having a meaning similar to “No problem”.

FIG. 5 is a diagram illustrating determination processing of a semantic relationship (second semantic relationship SR2) between a plurality of clusters CL. The determination unit 14 executes mapping of the semantic relationship as the determination processing.

For example, the determination unit 14 starts the processing using the original sentence in the state shown in the stage ST25 (see FIG. 3) and the representation table ET shown in the stage ST33 (see FIG. 4) (stage ST41). The determination unit 14 focuses on a first semantic relationship SR1 between the three linguistic representations LE1, LE2 and LE3 and the three linguistic representations LE1, LE2 and LE3. For example, the determination unit 14 focuses on the fact that there is a “Causal relationship” between the linguistic representation LE1 included in the cluster 1 and the linguistic representation LE2 included in the cluster 2. The determination unit 14 determines the “Causal relationship” between the linguistic representation LE1 and the linguistic representation LE2 as a “Causal relationship” between the cluster 1 and the cluster 2. Similarly, the determination unit 14 determines the “Reverse connection relationship” between the linguistic representation LE2 and the linguistic representation LE3 as a “Reverse connection relationship” between the cluster 2 and the cluster 3. That is, the determination unit 14 maps the first semantic relationship SR1 between the two linguistic representations LE to the second semantic relationship SR2 between the two clusters CL.

A relationship table RT shows the second semantic relationship SR2 between the two clusters CL (stage ST42). In a case where there is an orientation of a semantic relationship from one cluster to another cluster, the one cluster is also referred to as a “root cluster”, and the other cluster is also referred to as a “leaf cluster”. The relationship table RT has a 3×3 matrix with a combination of three root clusters and three leaf clusters. According to the relationship table RT, there is a “Causal relationship” between the cluster 1 and the cluster 2, and there is a “Reverse connection relationship” between the cluster 2 and the cluster 3. The relationship table RT may have similar information for other clusters different from the clusters 1 to 3.

Note that, for a first cluster (root cluster) and a second cluster (leaf cluster), the determination unit 14 may determine strength related to a semantic relationship from the first cluster to the second cluster. For example, the determination unit 14 uses the number N(X) of a plurality of first linguistic representations included in the first cluster, the number N(Y) of a plurality of second linguistic representations included in the second cluster, and the number N(X→Y) of a first semantic relationship SR1 from the plurality of first linguistic representations to the plurality of second linguistic representations. The determination unit 14 may determine the strength related to the semantic relationship from the first cluster to the second cluster by a formula “N(X→Y)/(N(X)× N(Y))”. This formula calculates proportion of the total number N(X→Y) of the semantic relationships from the first cluster to the second cluster to the total number (N(X)×N(Y)) of the semantic relationships due to combinations between the plurality of first linguistic representations and the plurality of second linguistic representations.

Subsequently, the determination unit 14 may determine whether or not the strength related to the semantic relationship is greater than or equal to a threshold value. In a case where the strength is greater than or equal to the threshold value, the determination unit 14 may determine the first semantic relationship SR1 from one of the plurality of first linguistic representations to one of the plurality of second linguistic representations as the second semantic relationship SR2 from the first cluster to the second cluster. The threshold value may be set to a predetermined value, or may be set to an arbitrary value by a user or the like.

FIG. 6 is a diagram illustrating a graph 3A. The graph 3A expresses the cluster CL in the relationship table RT as a node ND, and expresses the second semantic relationship SR2 between the plurality of clusters CL as an edge ED. Clusters 1 to 5 correspond to nodes ND1 to ND5, respectively. The edge ED from one cluster (root cluster) to another cluster (leaf cluster) is expressed by arranging a number of the one cluster and a number of the alternative cluster in this order. For example, the edge ED from the cluster 1 to the cluster 2 is expressed as an “edge ED12”.

The plurality of edges ED may be input to a certain cluster. For example, two edges ED12 and ED42 are input to the cluster 2. The plurality of edges ED may be output from a certain cluster. For example, two edges ED12 and ED14 are output from the cluster 1. Furthermore, there may be an edge ED that is output from a certain cluster and returns to the certain cluster (that is, a self-loop). For example, an edge ED22 is output from the cluster 2 and returns to the cluster 2.

According to the document summarization apparatus 1A described above, the extraction unit 12 executes natural language processing for the text included in the document 2A, and extracts the plurality of linguistic representations LE and the first semantic relationship SR1 between the plurality of linguistic representations LE from the text. The classification unit 13 classifies the plurality of linguistic representations LE into the plurality of clusters CL based on semantic similarity. The determination unit 14 determines the second semantic relationship SR2 between the plurality of clusters CL based on the first semantic relationship SR1. The generation unit 15 generates the graph 3A representing the plurality of clusters CL and the second semantic relationship SR2.

That is, since the document summarization apparatus 1A classifies the plurality of linguistic representations LE extracted from the document 2A into the plurality of clusters CL, the plurality of linguistic representations LE having similar meanings can be aggregated into the same cluster CL (or the node ND). Furthermore, since the document summarization apparatus 1A aggregates the first semantic relationship SR1 between the plurality of linguistic representations LE into the second semantic relationship SR2 (or the edge ED) between the plurality of clusters CL, the number of first semantic relationships SR1 can be reduced to the number of second semantic relationships SR2. Therefore, the document summarization apparatus 1A can summarize the document 2A more concisely.

### Second Embodiment

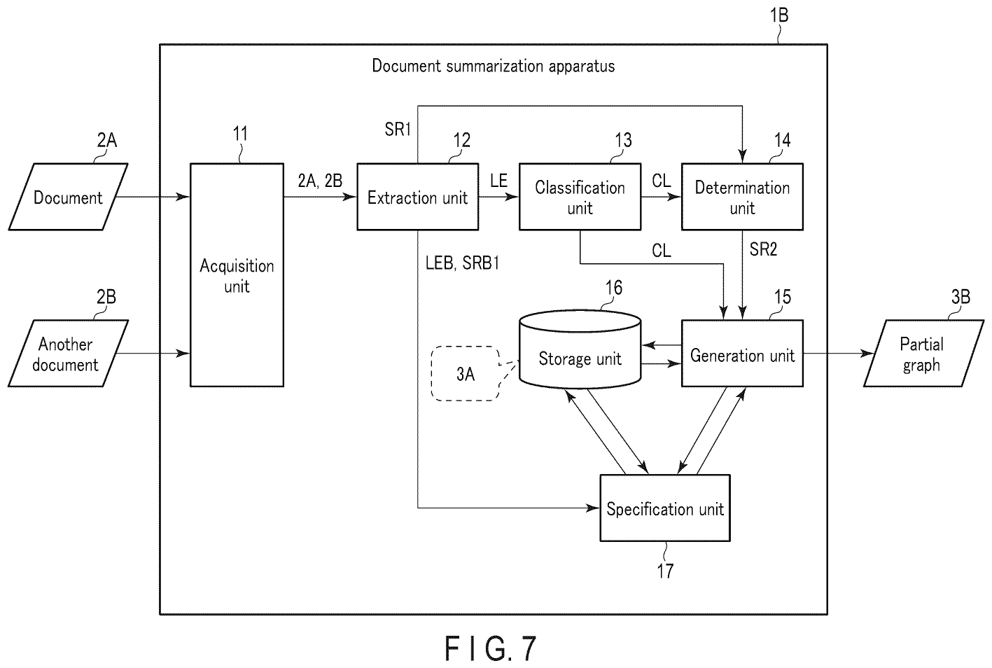

FIG. 7 is a functional configuration diagram of a document summarization apparatus 1B according to a second embodiment. The document summarization apparatus 1B further includes a storage unit 16 and a specification unit 17 in addition to an acquisition unit 11, an extraction unit 12, a classification unit 13, a determination unit 14, and a generation unit 15 included in a document summarization apparatus 1A.

The acquisition unit 11 further acquires another document 2B in addition to a document 2A from an external database or the like. The alternative document 2B is similar to the document 2A. The acquisition unit 11 transmits the acquired document 2A and the alternative document 2B to the extraction unit 12.

The extraction unit 12 executes natural language processing for another text included in the alternative document 2B, and extracts another plurality of linguistic representations LEB and another first semantic relationship SRB1 between the alternative plurality of linguistic representations LEB from the alternative text. The extraction unit 12 may extract the alternative plurality of linguistic representations LEB by executing named entity extraction. The extraction unit 12 may extract the alternative first semantic relationship SRB1 by executing relationship extraction. The extraction unit 12 transmits the extracted another plurality of linguistic representations LEB and another first semantic relationship SRB1 to the specification unit 17.

The generation unit 15 generates a partial graph 3B representing a portion specified by the specification unit 17 in a graph 3A. The partial graph 3B is similar to the graph 3A. The generation unit 15 outputs the generated partial graph 3B to an external display device or the like.

The storage unit 16 is a unit that stores various data. The storage unit 16 stores the graph 3A generated by the generation unit 15. The storage unit 16 transmits the stored graph 3A to the generation unit 15 or the specification unit 17.

The specification unit 17 is a unit that specifies various data. From the graph 3A, the specification unit 17 specifies a portion that corresponds to the alternative plurality of linguistic representations LEB and the alternative first semantic relationship SRB1 and represents a plurality of clusters CL and a second semantic relationship SR2. The specification unit 17 transmits the specified portion to the generation unit 15.

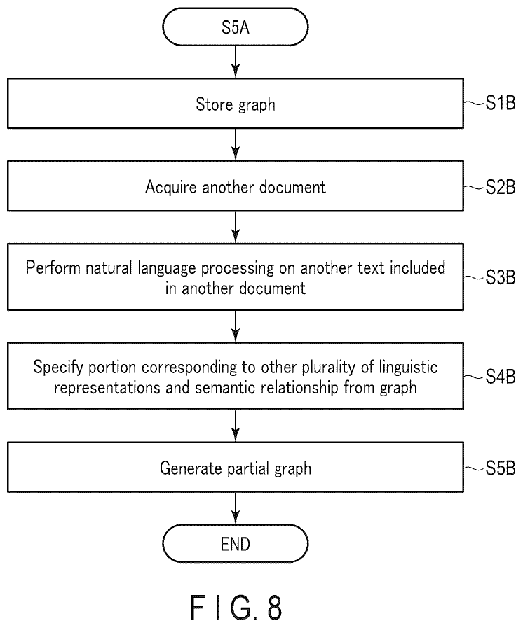

FIG. 8 is a flowchart of the document summarization apparatus 1B according to the second embodiment. The document summarization apparatus 1B may execute a series of processing similar to those of the document summarization apparatus 1A. The document summarization apparatus 1B executes the following steps S1B to S5B following step S5A (see FIG. 2).

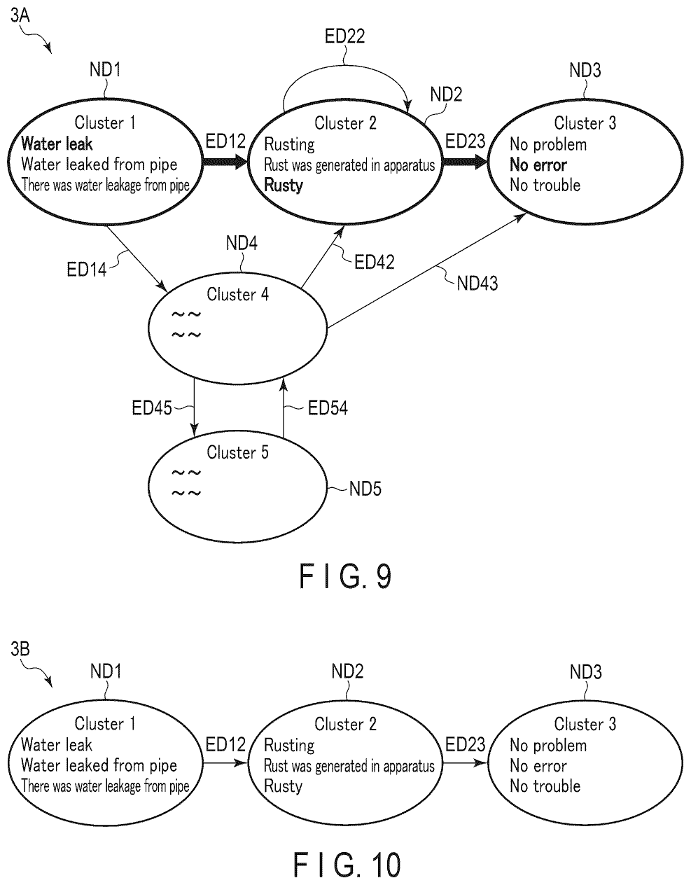

(Step S1B) First, the storage unit 16 stores a graph 3A. For example, the storage unit 16 stores the graph 3A generated in step S5A.
(Step S2B) Next, the acquisition unit 11 acquires another document 2B. For example, the acquisition unit 11 acquires the alternative document 2B from the external database or the like.
(Step S3B) Subsequently, the extraction unit 12 performs natural language processing on another text included in the alternative document 2B. For example, the extraction unit 12 executes named entity extraction and relationship extraction for the alternative text, and extracts another plurality of linguistic representations LEB and another first semantic relationship SRB1 from the alternative text. Step S3B is similar to step S2A (see FIG. 2).
(Step S4B) Subsequently, the specification unit 17 specifies, from the graph 3A, a portion corresponding to the alternative plurality of linguistic representations LEB and the semantic relationship (the alternative first semantic relationship SRB1). For example, from the graph 3A, the specification unit 17 specifies a plurality of linguistic representations LE corresponding to the alternative plurality of linguistic representations LEB, and specifies a plurality of clusters CL (or nodes ND) including the specified plurality of linguistic representations LE. In a case where there is no linguistic representation LE corresponding to a certain linguistic representation LEB in the graph 3A, the specification unit 17 ignores the linguistic representation LEB. On the other hand, the specification unit 17 specifies an edge ED corresponding to the alternative first semantic relationship SRB1 between the alternative plurality of linguistic representations LEB from the graph 3A. In a case where an edge ED corresponding to another certain first semantic relationship SRB1 does not exist in the graph 3A, the specification unit 17 ignores the alternative first semantic relationship SRB1 (see FIG. 9).

Thereafter, the specification unit 17 integrates the plurality of clusters CL and edges ED specified from the graph 3A to specify a portion corresponding to the alternative plurality of linguistic representations LEB and the semantic relationship. On the contrary, the specification unit 17 excludes a remaining portion not corresponding to the portion from the graph 3A.

(Step S5B) Finally, the generation unit 15 generates a partial graph 3B. For example, the generation unit 15 generates the partial graph 3B based on the portion specified by the specification unit 17 (see FIG. 10).

FIG. 9 is a diagram illustrating processing of specifying a portion from the graph 3A. For convenience of description, the portion specified from the graph 3A is illustrated by a thick line and boldface. Each of clusters 1 to 5 in the graph 3A includes a plurality of linguistic representations LE.

For example, the specification unit 17 specifies three linguistic representations LE (Water leak, Rusty, No error) corresponding to the alternative plurality of linguistic representations LEB, and specifies three clusters CL (a cluster 1, a cluster 2, and a cluster 3) including the three linguistic representations LE, respectively. On the other hand, the specification unit 17 specifies two edges ED (edge ED12, edge ED23) corresponding to the alternative first semantic relationship SRB1. The specification unit 17 integrates the specified three clusters CL and two edges ED to specify a portion in the graph 3A.

FIG. 10 is a diagram illustrating an example of the partial graph 3B. The partial graph 3B shows a portion specified from the graph 3A. The portion includes three clusters CL (cluster 1, cluster 2, cluster 3) and two edges ED (edge ED12, edge ED23). The portion may be emphasized by any mode (for example, a thick line, boldface, and blinking).

According to the document summarization apparatus 1B described above, the extraction unit 12 executes natural language processing for the alternative text included in the alternative document 2B, and extracts the alternative plurality of linguistic representations LEB and the alternative first semantic relationship SRB1 between the alternative plurality of linguistic representations LEB from the alternative text. From the graph 3A, the specification unit 17 specifies a portion that corresponds to the alternative plurality of linguistic representations LEB and the alternative first semantic relationship SRB1 and represents a plurality of clusters CL and a second semantic relationship SR2. The generation unit 15 generates the partial graph 3B representing the portion.

In general, the alternative document 2B may contain a number of linguistic representations. Therefore, in a case where all the linguistic representations and the semantic relationships extracted from the alternative document 2B are presented to a user, it is difficult for the user to understand the presented information.

The document summarization apparatus 1B specifies a portion corresponding to the plurality of linguistic representations and semantic relationships extracted from the alternative document 2B from the graph 3A generated in advance. The document summarization apparatus 1B generates the partial graph 3B representing the specified portion. That is, since the document summarization apparatus 1B aggregates the plurality of linguistic representations and the semantic relationships extracted from the alternative document 2B into the plurality of clusters and the semantic relationships in the partial graph 3B, the alternative document 2B can be summarized more concisely.

### Third Embodiment

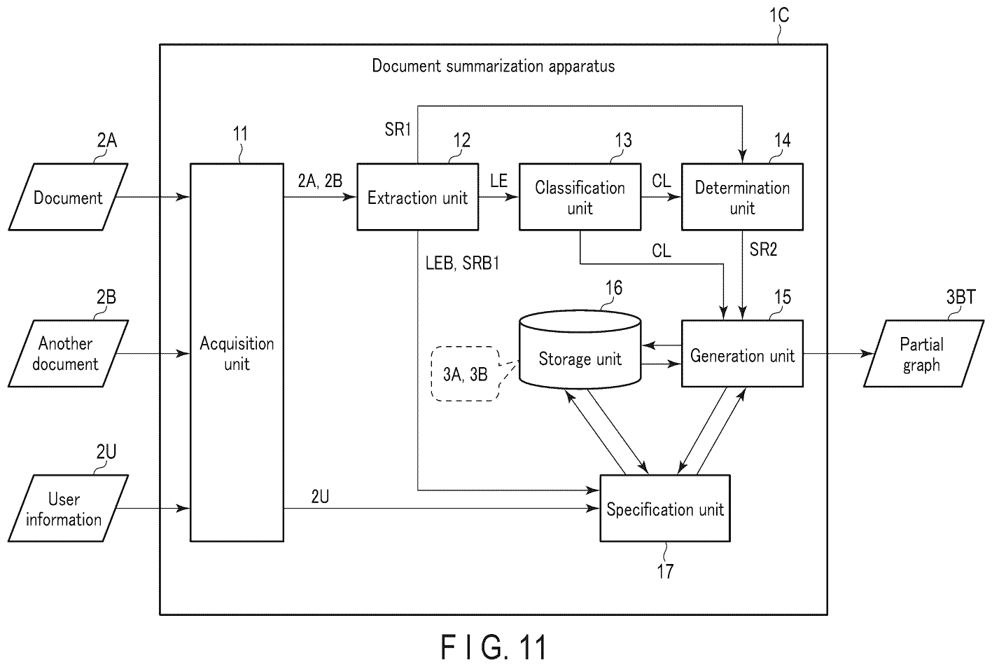

FIG. 11 is a functional configuration diagram of a document summarization apparatus 1C according to a third embodiment. The document summarization apparatus 1C includes an acquisition unit 11, an extraction unit 12, a classification unit 13, a determination unit 14, a generation unit 15, a storage unit 16, and a specification unit 17 similarly to a document summarization apparatus 1B.

The acquisition unit 11 further acquires user information 2U in addition to a document 2A and another document 2B from an external database or the like. The acquisition unit 11 transmits the acquired document 2A and another document 2B to the extraction unit 12, and the acquired user information 2U to the specification unit 17.

The user information 2U is attribute information related to a user to whom a partial graph 3B is presented. The user information 2U includes (1) personal information regarding an individual of the user, (2) skill information regarding skills of the user, (3) business information regarding work of the user, and the like. The personal information is a name, an age, a gender, an address, a contact address, and the like. The skill information includes a job history, an engagement period, a qualification, and the like. The business information is a department, a device number, a manufacturing process, an apparatus, and the like.

In particular, the business information may include influence degree information regarding an influence degree of a trouble generated by the user during operations. The influence degree information is occurrence frequency, stop time, damage, and the like.

The generation unit 15 generates the partial graph 3B. The generation unit 15 transmits the generated partial graph 3B to the storage unit 16 or the specification unit 17. The generation unit 15 generates a partial graph 3BT emphasizing a linguistic representation LE specified by the specification unit 17 in the partial graph 3B. The generation unit 15 outputs the generated partial graph 3BT to an external display device or the like.

The storage unit 16 stores the partial graph 3B generated by the generation unit 15. The storage unit 16 transmits the stored partial graph 3B to the generation unit 15 or the specification unit 17.

The specification unit 17 specifies a linguistic representation LE related to the user information 2U from a plurality of clusters CL in the partial graph 3B based on the user information 20. The specification unit 17 transmits the specified linguistic representation LE to the generation unit 15.

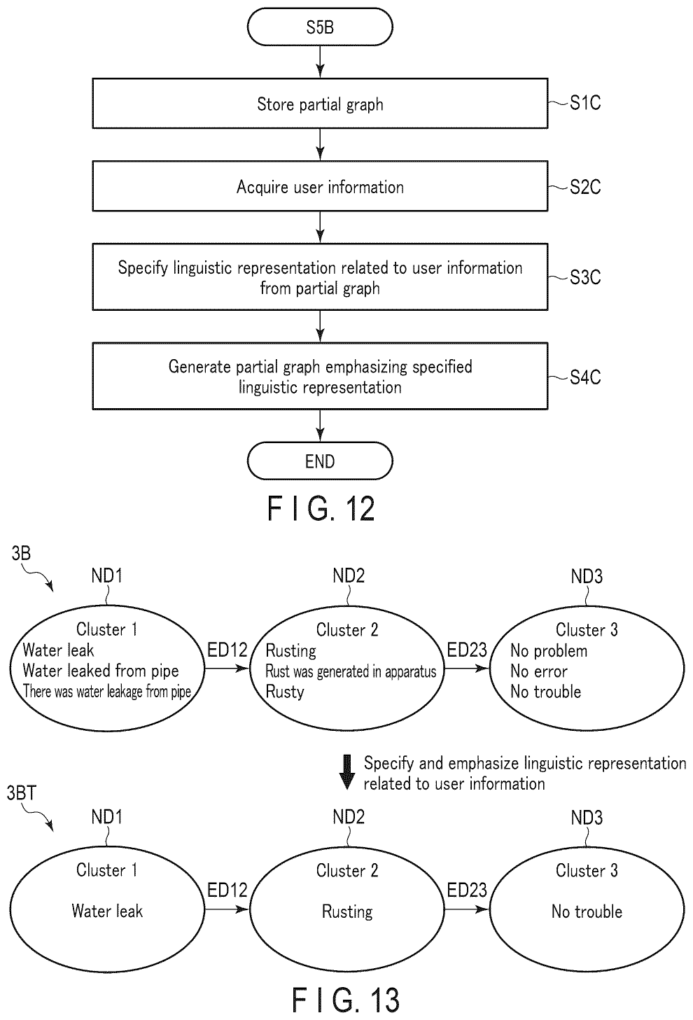

FIG. 12 is a flowchart of the document summarization apparatus 1C according to the third embodiment. The document summarization apparatus 1C may execute a series of processing similar to those of the document summarization apparatus 1B. The document summarization apparatus 1C executes the following steps S1C to S4C following step S5B (see FIG. 8).

(Step S1C) First, the storage unit 16 stores a partial graph 3B. For example, the storage unit 16 stores the partial graph 3B generated in step S5B.
(Step S2C) Next, the acquisition unit 11 acquires user information 2U. For example, the acquisition unit 11 acquires the user information 2U from the external database or the like.
(Step S3C) Subsequently, the specification unit 17 specifies a linguistic representation LE related to the user information 2U from the partial graph 3B. For example, the specification unit 17 specifies the linguistic representation LE related to the user information 2U from the plurality of linguistic representations LE included in the plurality of clusters CL in the partial graph 3B (see FIG. 13).
(Step S4C) Finally, the generation unit 15 generates a partial graph 3BT emphasizing the specified linguistic representation LE. For example, the generation unit 15 emphasizes the specified linguistic representation LE as a representative notation of the cluster CL. The generation unit 15 may emphasize a character representing the linguistic representation LE by an arbitrary mode (for example, boldface, italic, and blinking). On the other hand, the generation unit 15 may delete the linguistic representation LE that has not been specified from the cluster CL (see FIG. 13).

FIG. 13 is a diagram illustrating another example of the partial graph 3B (that is, the partial graph 3BT). For example, it is assumed that the partial graph 3B is a summary regarding a “unit X” and the user to whom the partial graph 3B is presented is a person in charge of a “unit Y”. In this case, the plurality of clusters CL in the partial graph 3B include the linguistic representation LE regarding the “unit X”. On the other hand, the plurality of clusters CL in the partial graph 3B may also include the linguistic representation LE regarding the “unit Y”.

Therefore, the specification unit 17 specifies the linguistic representation LE related to the “unit Y” from the plurality of clusters CL in the partial graph 3B. For example, the specification unit 17 specifies three linguistic representations LE (Water leak, Rusting, No trouble) related to the “unit Y” from the three clusters CL. The generation unit 15 generates the partial graph 3BT enlarging and emphasizing the specified three linguistic representations LE.

According to the document summarization apparatus 1C described above, based on the user information 2U related to the user presented by the partial graph 3B, the specification unit 17 specifies the linguistic representation LE related to the user information 2U from the plurality of clusters CL in the partial graph 3B. The generation unit 15 generates the partial graph 3BT emphasizing the specified linguistic representation LE.

The user checks the partial graph 3BT on the display device. First, in a case where the user's “personal information” or “skill information” is used as the user information 20, the user can understand that another person similar to the user has caused a trouble and can empathize with the trouble. Second, in a case where the user's “business information” is used as the user information 2U, the user can understand that a trouble related to the user's business has caused a trouble and can empathize with the trouble. Third, in a case where “influence degree information” of a trouble caused by the user is used as the user information 2U, the user can understand how serious the presented trouble should be.

Generally, a trouble report is shared by a plurality of readers in a state where contents (for example, a phenomenon, investigation, cause, countermeasure, and result) are generalized or abstracted. However, there is a concern that the reader does not carefully read such a trouble report for reasons such as a relevance to his/her own attribute or a lack of interest.

Therefore, the document summarization apparatus 1C specifies and emphasizes the linguistic representation related to the user information 2U from the partial graph 3B which is an abstract of the trouble report using the user information 2U related to the attribute of the reader (that is, the user). Therefore, the user is expected to carefully read the presented trouble since the user can feel relevance to his/her attribute or interest.

### Fourth Embodiment

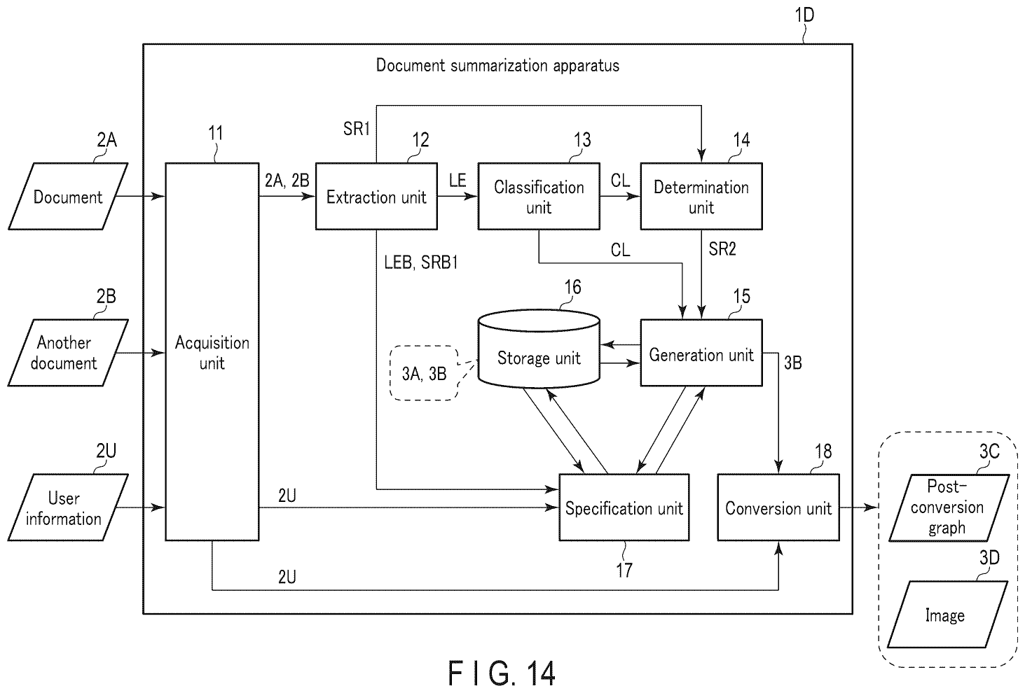

FIG. 14 is a functional configuration diagram of a document summarization apparatus 1D according to a fourth embodiment. The document summarization apparatus 1D further includes a conversion unit 18 in addition to an acquisition unit 11, an extraction unit 12, a classification unit 13, a determination unit 14, a generation unit 15, a storage unit 16, and a specification unit 17 included in a document summarization apparatus 1C.

The conversion unit 18 is a unit that converts various data into other data. The conversion unit 18 receives user information 2U from the acquisition unit 11 and receives a partial graph 3B from the generation unit 15. First, the conversion unit 18 inputs the user information 2U and a linguistic representation LE included in a plurality of clusters CL in the partial graph 3B to a large-scale language model (or generative AI), and converts the input linguistic representation into a linguistic representation LE related to the user information 2U. The conversion unit 18 outputs the partial graph 3B including the converted linguistic representation LE (that is, a post-conversion graph 3C) to an external display device or the like.

Second, the conversion unit 18 inputs the linguistic representation LE included in the plurality of clusters CL in the partial graph 3B to the large-scale language model (or generative AI), and converts the input linguistic representation into an image 3D. The conversion unit 18 outputs the image 3D to the external display device or the like.

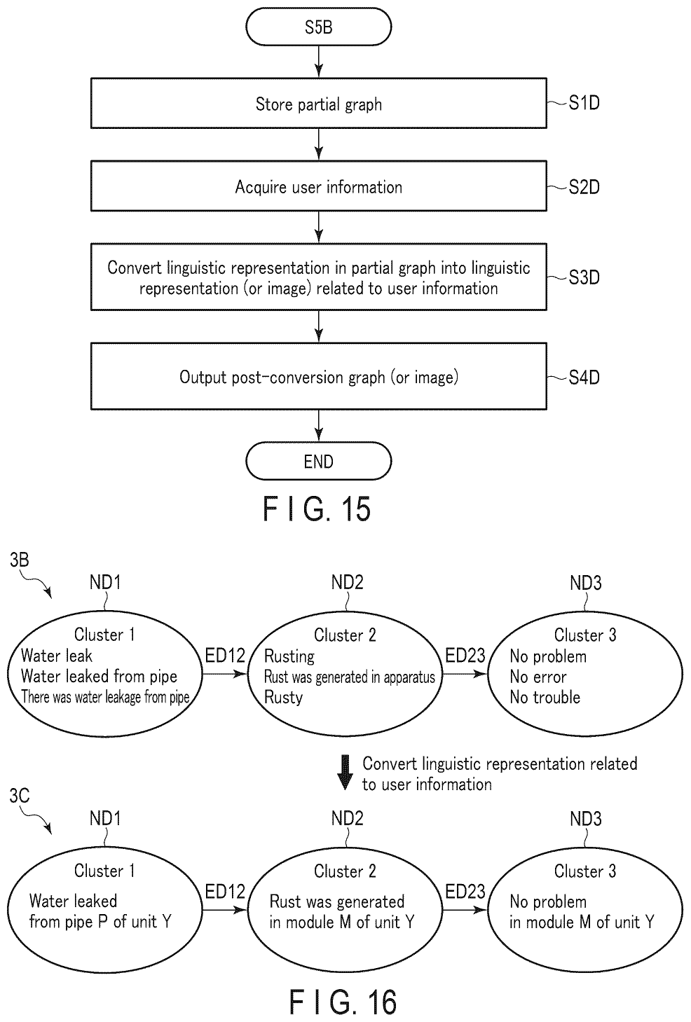

FIG. 15 is a flowchart of the document summarization apparatus 1D according to the fourth embodiment. The document summarization apparatus 1D may execute a series of processing similar to those of the document summarization apparatus 1B. The document summarization apparatus 1D executes the following steps S1D to S4D following step S5B (see FIG. 8).

(Step S1D) First, the storage unit 16 stores a partial graph 3B. For example, the storage unit 16 stores the partial graph 3B generated in step S5B. Step S1D is similar to step S1C (see FIG. 12).
(Step S2D) Next, the acquisition unit 11 acquires a user information 2U. For example, the acquisition unit 11 acquires the user information 2U from the external database or the like. Step S2D is similar to step S2C (see FIG. 12).
(Step S3D) Subsequently, the conversion unit 18 converts a linguistic representation LE in the partial graph 3B into a linguistic representation LE (or an image 3D) related to the user information 2U. First, the conversion unit 18 may input the user information 2U and the linguistic representation LE to be converted to the large-scale language model, and convert the input linguistic representation LE into the linguistic representation LE related to the user information 2U. At this time, the large-scale language model may also be input with a prompt to “Convert to linguistic representation related to user information” (see FIG. 16).

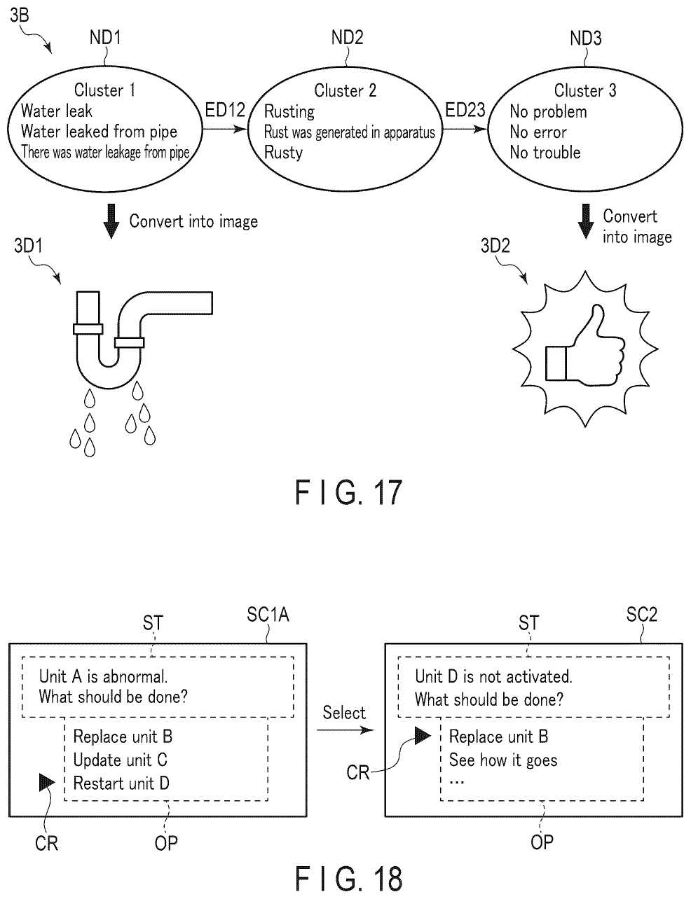

Secondly, the conversion unit 18 may input the linguistic representation LE to be converted into the large-scale language model, and convert the input linguistic representation LE into the image 3D. At this time, the large-scale language model may also be input with a prompt to “Convert into image” (see FIG. 17).

(Step S4D) Finally, the conversion unit 18 outputs a post-conversion graph 3C (or the image 3D) to the external display device or the like. The conversion unit 18 may output both the post-conversion graph 3C and the image 3D to the same display device or the like.

FIG. 16 is a diagram illustrating conversion processing from the linguistic representation LE to the alternative linguistic representation LE. For example, the plurality of clusters CL in the partial graph 3B do not include a linguistic representation LE related to a “unit Y” which a user to whom the partial graph 3B is presented is in charge. In this case, the conversion unit 18 may convert the linguistic representation LE in each of the plurality of clusters CL into a fictitious linguistic representation LE related to a trouble in the “unit Y” that does not actually occur.

First, the conversion unit 18 converts the linguistic representation LE “Water leaked from pipe” in a cluster 1 into another linguistic representation LE “Water leaked from pipe P of unit Y”. Secondly, the conversion unit 18 converts the linguistic representation LE “Rust was generated in apparatus” in a cluster 2 into another linguistic representation LE “Rust was generated in module M of unit Y”. Thirdly, the conversion unit 18 converts the linguistic representation LE “No problem” in a cluster 3 into another linguistic representation LE “No problem in module M of unit Y”.

The post-conversion graph 3C includes the linguistic representation LE converted by the conversion unit 18. The converted linguistic representation LE may be used as a representative notation of the cluster CL.

FIG. 17 is a diagram illustrating conversion processing from the linguistic representation LE to the image 3D. For example, the conversion unit 18 converts the linguistic representation LE “Water leaked from pipe” in the partial graph 3B into an image 3D1 expressing this linguistic representation LE. Similarly, the conversion unit 18 converts the linguistic representation LE “No problem” in the partial graph 3B into an image 3D2 expressing this linguistic representation LE.

According to the document summarization apparatus 1D described above, the conversion unit 18 inputs the user information 2U related to the user presented by the partial graph 3B and the linguistic representation LE included in the plurality of clusters CL in the partial graph 3B to the large-scale language model, and converts the input linguistic representation LE into the linguistic representation LE related to the user information 2U.

The user checks the converted linguistic representation LE (or the post-conversion graph 3C) on the display device. The converted linguistic representation LE contains information related to the user. Therefore, the user is expected to carefully read the post-conversion graph 3C because the user can feel relevance to his/her attribute or interest.

Alternatively, according to the document summarization apparatus 1D, the conversion unit 18 inputs the linguistic representation LE included in the plurality of clusters CL in the partial graph 3B to the large-scale language model, and converts the input linguistic representation LE into the image 3D.

The image 3D visually represents the linguistic representation LE. Therefore, the user can more easily understand contents of the post-conversion graph 3C at a glance.

### Modification

According to a document summarization apparatus 1B according to a second embodiment, a generation unit 15 generates a partial graph 3B. At this time, the generation unit 15 may generate an interactive display screen that responds to an action from a user based on a causal relationship between a plurality of clusters CL in the partial graph 3B. The display screen may have options in a game book or an adventure game.

For example, the generation unit 15 focuses on a plurality of third clusters (root clusters) and a plurality of fourth clusters (leaf clusters) in the partial graph 3B. In a case where there is a causal relationship from the plurality of third clusters to the plurality of fourth clusters, the generation unit 15 may generate a first display screen including a linguistic representation from each of the plurality of third clusters. Further, in a case where one linguistic representation on the first display screen is selected, the generation unit 15 focuses on the fourth cluster (leaf cluster) having the causal relationship with respect to the third cluster (root cluster) including the selected linguistic representation. The generation unit 15 may generate a second display screen including a linguistic representation from the fourth cluster (see FIG. 18).

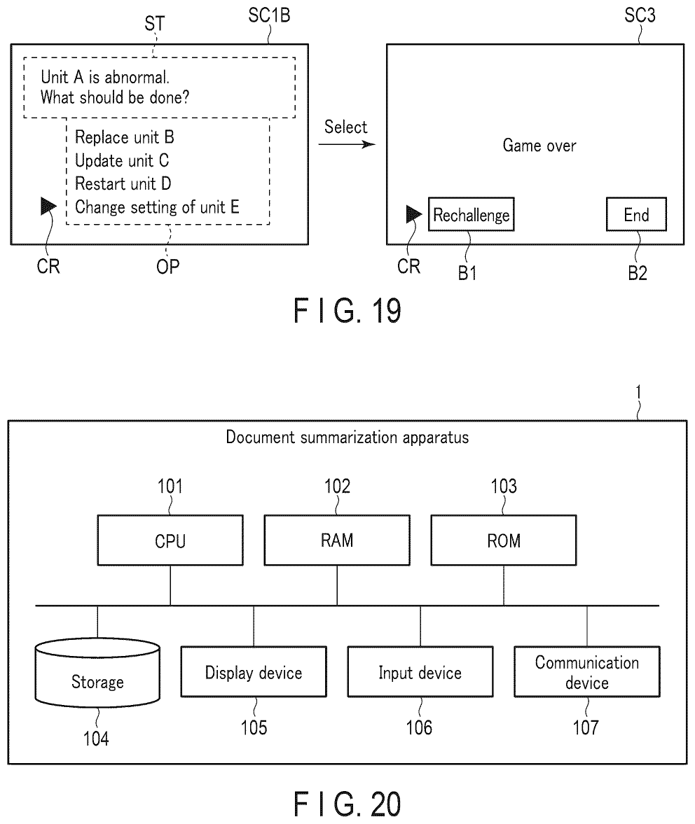

On the other hand, the generation unit 15 may generate a first display screen including a linguistic representation from a fifth cluster (root cluster) having no causal relationship with the plurality of fourth clusters (leaf clusters). Further, in a case where the linguistic representation from the fifth cluster on the first display screen is selected, the generation unit 15 may not generate the second display screen. Alternatively, the generation unit 15 may generate a display screen (for example, “game over screen”) indicating that the screen cannot transition to the next display screen (see FIG. 19).

FIG. 18 is a diagram illustrating an example of display screen transition processing according to the modification. A first display screen SC1A and a second display screen SC2 include a situation ST, an option OP, and a cursor CR. The situation ST is a sentence describing a current situation (or context). The option OP is a selectable measure (or command) for the situation ST. The cursor CR can be operated by a user through an input device.

In the first display screen SC1A, the situation ST includes a linguistic representation from one cluster (root cluster) having a causal relationship with a plurality of third clusters (leaf clusters). Specifically, the situation ST includes a sentence “Unit A is abnormal. What should be done?”. As an option OP for this situation ST, three options (Replace unit B, Update unit C, and Restart unit D) are presented. The user moves the cursor CR up and down and selects a desired option (for example, “Restart unit D”). In response to this selection, the first display screen SC1A transitions to a second display screen SC2.

In the second display screen SC2, the situation ST includes a linguistic representation from a fourth cluster (leaf cluster) having a causal relationship with a third cluster (root cluster) including the selected option. Specifically, the situation ST includes a sentence “Unit D is not activated. What should be done?”. As the option OP for this situation, a plurality of options (Replace unit B, See how it goes, . . . ) are presented. The option OP may include linguistic representations from the remaining third clusters that were not selected. The user moves the cursor CR up and down and selects a desired option (for example, “Replace unit B”). In response to this selection, the second display screen SC2 transitions to another display screen in the same way as described above.

In this manner, the generation unit 15 generates an interactive display screen that responds to an action from the user. The display screen is generated based on an actual trouble that has occurred in the past and a measure taken for the trouble. Therefore, since the user can experience in a pseudo manner how to deal with an actual trouble that the user has not experienced, it is possible to improve skills related to dealing with a trouble. Furthermore, the user can more easily understand contents of the trouble at a glance, and can learn how to deal with the trouble while enjoying it with a game feeling.

FIG. 19 is a diagram illustrating another example of the display screen transition processing according to the modification. In a first display screen SC1B, the situation ST includes the sentence “Unit A is abnormal. What should be done?”. As the option OP for this situation, four options (Replace unit B, Update unit C, Restart unit D, and Change setting of unit E) are presented. The user moves the cursor CR up and down and selects a desired option (for example, “Change setting of unit E”).

However, the option “Change setting of unit E” is irrelevant or inappropriate as a measure against the trouble “abnormality of unit A”. In response to the selection of the option (that is, a dummy option), the first display screen SC1B does not transition to the second display screen SC2, but transitions to a third display screen SC3.

The third display screen SC3 includes a text “Game over”. A rechallenge button B1 and an end button B2 are arranged below this text. The user moves the cursor CR left or right, and selects the rechallenge button B1 or the end button B2. In response to the selection of the rechallenge button B1, the third display screen SC3 may transition to the first display screen SC1B. In response to the selection of the end button B2, the third display screen SC3 may be deleted.

In this manner, the generation unit 15 mixes irrelevant or inappropriate options in the first display screen SC1B. In a case where this option is selected, the first display screen SC1B transitions to the third display screen SC3 in which there is no option for coping with the trouble. Therefore, the user can easily understand that the selected option is irrelevant or inappropriate as a measure for trouble.

FIG. 20 is a hardware configuration diagram of a document summarization apparatus 1 according to each embodiment. A document summarization apparatus 1 includes a CPU 101, a RAM 102, a ROM 103, a storage 104, a display device 105, an input device 106, and a communication device 107 as components. The components are communicably connected to each other by an internal bus. The document summarization apparatus 1 may include at least some of the components.

The CPU 101 is a processor that executes various processing in accordance with a program. The CPU 101 uses a predetermined area of the RAM 102 as a work area. The CPU 101 reads and executes each program stored in the ROM 103 or the storage 104 to implement each unit (for example, an acquisition unit 11, an extraction unit 12, a classification unit 13, a determination unit 14, a generation unit 15, a specification unit 17, and a conversion unit 18). Each unit may be realized by a dedicated hardware circuit (for example, ASIC, PLD, and FPGA). Each unit may be implemented in an on-premises or cloud. The CPU 101 is an example of a processing unit.

The RAM 102 is a memory that rewritably stores various data. For example, the RAM 102 is a synchronous dynamic random access memory (SDRAM). The RAM 102 is an example of the storage unit 16.

The ROM 103 is a memory that unrewritably stores various data. The ROM 103 is an example of the storage unit 16.

The storage 104 is various storage media. The storage 104 may be a drive device that writes various data to a storage medium or reads various data from the storage medium. The storage 104 may be controlled by the CPU 101. The storage 104 is an example of the storage unit 16.

The display device 105 is a device that displays various data. The display device 105 may be a liquid crystal display (LCD). The display device 105 displays various data based on a display signal from the CPU 101. The display device 105 is an example of a display unit.

The input device 106 is a device that receives various input operations from a user. The input device 106 may be a mouse or a keyboard. The input device 106 receives an operation input by the user as an instruction signal, and transmits the instruction signal to the CPU 101. The input device 106 is an example of an input unit.

The communication device 107 communicates with an external device via a network in accordance with control by the CPU 101. The communication device 107 is an example of a communication unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document summarization apparatus comprising a processor configured to:
perform natural language processing on text included in a document to extract a plurality of linguistic representations and a first semantic relationship between the linguistic representations from the text;
classify the linguistic representations into a plurality of clusters by semantic similarity;
determine a second semantic relationship between the clusters based on the first semantic relationship; and
generate a graph representing the clusters and the second semantic relationship.

2. The apparatus according to claim 1, wherein
the processor is further configured to determine, for a first cluster and a second cluster among the clusters, the second semantic relationship between the first cluster and the second cluster based on the first semantic relationship between a plurality of first linguistic representations included in the first cluster and a plurality of second linguistic representations included in the second cluster.

3. The apparatus according to claim 2, wherein
the processor is further configured to determine the first semantic relationship between one of the first linguistic representations and one of the second linguistic representations as the second semantic relationship between the first cluster and the second cluster.

4. The apparatus according to claim 2, wherein
the processor is further configured to determine strength related to the second semantic relationship from the first cluster to the second cluster using a number of the first linguistic representations, a number of the second linguistic representations, and a number of the first semantic relationships from the first linguistic representations to the second linguistic representations.

5. The apparatus according to claim 4, wherein
the processor is further configured to determine, in a case where the strength is greater than or equal to a threshold, the first semantic relationship from one of the first linguistic representations to one of the second linguistic representations as the second semantic relationship from the first cluster to the second cluster.

6. The apparatus according to claim 1, wherein
the processor is further configured to:
perform the natural language processing on another text included in another document to extract another plurality of linguistic representations and another first semantic relationship between the alternative linguistic representations from the alternative text,
specify, from the graph, a portion corresponding to the alternative linguistic representations and the alternative first semantic relationship and representing the clusters and the second semantic relationship, and
generate a partial graph representing the portion.

7. The apparatus according to claim 6, wherein
the processor is further configured to:
specify, based on user information related to a user to whom the partial graph is presented, a linguistic representation related to the user information from the clusters in the partial graph, and
generate the partial graph emphasizing the specified linguistic representation.

8. The apparatus according to claim 6, wherein
the processor is further configured to:
input user information related to a user to whom the partial graph is presented and a linguistic representation included in the clusters in the partial graph to a large-scale language model, and
convert the input linguistic representation into a linguistic representation related to the user information.

9. The apparatus according to claim 7, wherein
the user information includes at least one of personal information regarding an individual of the user, skill information regarding skills of the user, and business information regarding work of the user.

10. The apparatus according to claim 6, wherein
the processor is further configured to:
input a linguistic representation included in the clusters in the partial graph to a large-scale language model, and
convert the input linguistic representation into an image.

11. The apparatus according to claim 6, wherein
the processor is further configured to:
generate, for a plurality of third clusters and a plurality of fourth clusters in the partial graph, in a case where there is a causal relationship from the third clusters to the fourth clusters, a first display screen including a linguistic representation from each of the third clusters, and
generate, in a case where one linguistic representation in the first display screen is selected, a second display screen including a linguistic representation from the fourth cluster having the causal relationship for the third cluster including the selected linguistic representation.

12. The apparatus according to claim 11, wherein
the processor is further configured to:
generate the first display screen including a linguistic representation from a fifth cluster that does not have a causal relationship to the fourth clusters, and
does not generate the second display screen in a case where the linguistic representation from the fifth cluster in the first display screen is selected.

13. A document summarization method comprising causing a computer to:
perform natural language processing on text included in a document to extract a plurality of linguistic representations and a first semantic relationship between the linguistic representations from the text;
classify the linguistic representations into a plurality of clusters by semantic similarity;
determine a second semantic relationship between the clusters based on the first semantic relationship; and
generate a graph representing the clusters and the second semantic relationship.

14. A non-transitory computer readable medium including computer executable instructions, wherein the instructions, when executed by a processor, cause the processor to perform a method comprising:
performing natural language processing on text included in a document to extract a plurality of linguistic representations and a first semantic relationship between the linguistic representations from the text;
classifying the linguistic representations into a plurality of clusters by semantic similarity;
determining a second semantic relationship between the clusters based on the first semantic relationship; and
generating a graph representing the clusters and the second semantic relationship.
